(19) United States
(12) Patent Application Publication
(10) Pub. No.: US 2005/0057648 A1
(43) Pub. Date: Mar. 17, 2005

(54) Image pickup device and image pickup method

(76) Inventors: Yasuhito Ambiru, Tokorozawa-shi (JP); Hiroshi Yoshimura, Saitama-shi (JP); Isao Ooshima, Kawasaki-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/901,375

(22) Filed: Jul. 29, 2004

(30) Foreign Application Priority Data
Jul. 31, 2003 (JP) 2003-283498

(51) Int. Cl. H04N 7/18; H04B 1/66; H04N 9/47

(52) U.S. Cl. 348/143; 375/240.25; 375/240.24

(57) ABSTRACT

An image pickup device has an image pickup portion which picks up an image, a communication portion which makes communication with a plurality of external devices on a network, a setting portion which receives a signal from each of the plurality of external devices via the communication portion and sets a segment region of image information to be transmitted to the each external device and priority items of process parameters when the image information is transmitted, and a control portion which, upon determining process parameters in accordance with the priority items of the process parameters, transmits image information in the segment region, which is set in units of the each external device from the image information of the image picked up by the image pickup portion, to the each device on the network via the communication portion in correspondence to the determined process parameters.

### CROSS-REFERENCE TO RELATED APPLICATIONS

This application is based upon and claims the benefit of priority from prior Japanese Patent Application No. 2003-283498, filed Jul. 31, 2003, the entire contents of which are incorporated herein by reference.

### BACKGROUND OF THE INVENTION

1. Field of the Invention

The invention relates to an image pickup device such as a network camera, and in particular, to an image pickup device and an image pickup method for transmitting image information in segment regions set by a plurality of users.

2. Description of the Related Art

With recent wide spread use of digital devices, a wide variety of image information devices, such as digital cameras, are developed and produced. As such an image information device, for example, a video system having a network function is used.

Patent Document 1 (Jpn. Pat. Appln. KOKAI Publication No. 2003-111050) discloses a video distribution server and a video reception client system of the aforementioned type, in which when image information in a plurality of regions is supplied from a plurality of users, frame rates are determined in accordance with levels of interest to perform the information distribution.

However, according to the prior art described above, while the frame rates are determined corresponding to the levels of interest, there exists a problem in that the frame rates are not determined in accordance with other factors. More specifically, in the conventional apparatus, when the plurality of segment regions are set from the external devices, process parameters cannot be automatically determined sufficiently taking, for example, the areas of the segment regions, desired transfer speed rates, and image quality into consideration.

### BRIEF SUMMARY OF THE INVENTION

An embodiment of the invention provides an image pickup device comprising an image pickup portion which picks up an image; a communication portion which makes communication with a plurality of external devices on a network; a setting portion which receives a signal from each of the plurality of external devices via the communication portion and sets a segment region of image information to be transmitted to the each external device and priority items of process parameters when the image information is transmitted; and a control portion which, upon determining process parameters in accordance with the priority items of the process parameters, transmits image information in the segment region, which is set in units of the each external device from the image information of the image picked up by the image pickup portion, to the each device on the network via the communication portion in correspondence to the determined process parameters.

### BRIEF DESCRIPTION OF THE SEVERAL VIEWS OF THE DRAWING

FIG. 1 is a block diagram showing an embodiment of a configuration of an image pickup device of the invention;

FIG. 2 is an explanatory view showing an example of a method of connecting the image pickup device of the invention to a network;

FIG. 3 is a cross-sectional view showing the embodiment of the configuration of the image pickup device of the invention;

FIG. 4 is an explanatory view showing an example of an operation screen for setting a segment region in the image pickup device of the invention;

FIG. 5 is a flowchart showing an example of a method of setting a segment region in the image pickup device of the invention;

FIG. 6 is a flowchart showing an example of a per-user transmission process to be performed by the image pickup device of the invention;

FIG. 7 is a view showing an example of per-user registrations of segment regions in image pickup device of the invention;

FIG. 8 is a view showing an example of a per-user transmission process to be performed by the image pickup device of the invention; and

FIG. 9 is a view showing an example of a per-user transmission process to be performed by the image pickup device of the invention.

### DETAILED DESCRIPTION OF THE INVENTION

With reference to the drawings, an image pickup device of the invention will be described in detail hereinbelow.

<Network Camera which is an Image Pickup Device of the Invention>

(Configuration)

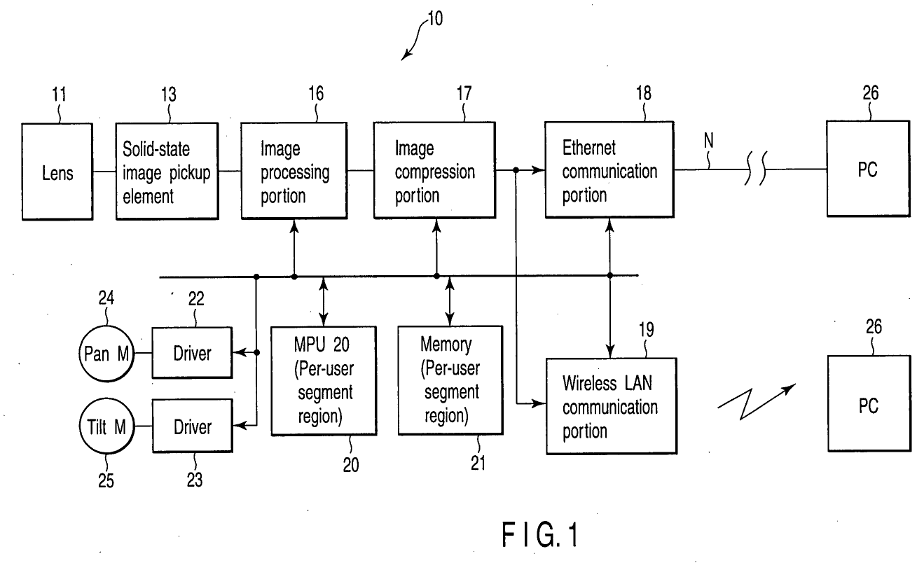

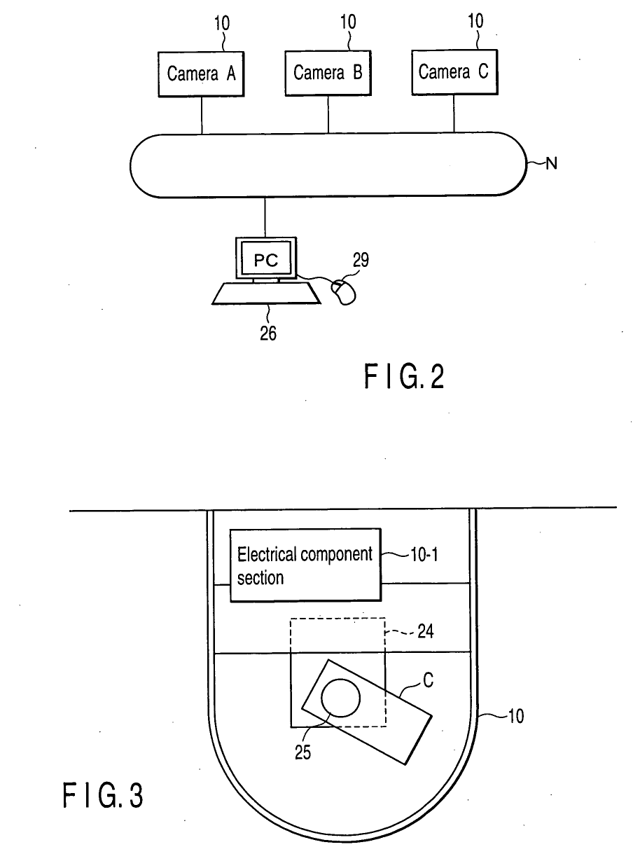

Using the drawings, an image pickup device of the invention will be described hereinbelow by reference to an example case of a PC (personal computer) connected to a network camera and a network. FIG. 1 is a block diagram showing an embodiment of a configuration of an image pickup device of the invention. FIG. 2 is an explanatory view showing an example of a method of connecting the image pickup device of the invention to the network. FIG. 3 is a cross-sectional view showing the embodiment of the configuration of the image pickup device of the invention.

Referring to FIG. 1, a network camera device 10, which is the image pickup device of the invention, has an objective lens 11 and a solid-state image pickup device 13 formed of, for example, a CCD (charge coupled device) which receives incident light traveled through the objective lens 11 and outputs a detection signal corresponding to the incident light. In addition, the network camera device 10 has an image processing portion 16 provided to receive the output from the solid-state image pickup device 13, and an image compression portion 17 provided to perform compression processing, such as MPEG compression or JPEG compression, of an image signal having undergone various image processings in the image processing portion 16. The image processings performed in the image processing portion 16 include sharpness processing, contrast processing, gamma correction processing, white-balance processing, and pixel addition processing.

In addition, the network camera device 10 has an MPU (main processing unit) 20 and a memory 21. The MPU 20 performs total control of processing and operations of the apparatus, and includes a function of a segmentation processing portion which performs segmentation processing and a function of a segment setting portion, which are will be described below as features of the invention. The memory 21 is used, for example, to store programs that manage such operations as those mentioned above, to provide work areas usable for execution of the individual processing operations for image signals, and to preserve coordinate information of per-user segment regions and screen data for alarm presentation to be displayed at the time of motion detection and the like.

In addition, the network camera device 10 has an Ethernet communication portion 18 and a wireless LAN (local area network) communication portion 19 that are connected to the MPU 20 via a data bus. The network camera device 10 is enabled thereby to perform the process of communication with, for example, each individual external PC 26 via a wired network N or a wireless network.

The network camera device 10 further has a pan driver 22, that is connected to the MPU 20 via the data bus, for driving the camera unit C in a pan direction; a pan motor 24 formed of a stepping motor or the like; a tilt driver 23 for driving the camera unit C in a tilt direction; and a tilt motor 25 formed of a stepping motor or the like. The camera unit C has at least the objective lens 11 and the solid-state image pickup device 13.

As shown in FIG. 2, a plurality of network camera devices 10 may be provided via the wired network N. In addition, the network camera device 10 can be driven in the tilt direction and the pan direction by using the PC 26 or the like via the network N. Additionally, monitoring, and record/reproduction processes can be performed for an image signal of an image picked up by the network camera device 10. Further, a pointing device such as a mouse 27 is connected to the PC 26, whereby, particularly, setting of the segment regions described below can easily be performed.

Further, as shown in FIG. 3, the network camera device 10 is configured to have the camera unit C, the pan motor 24 for driving the camera unit C in the pan direction, the tilt motor 25 for moving the camera unit C in the tilt direction, and an electrical component section 10-1 having other portions of the configuration shown in FIG. 1.

(Basic Operations)

The network camera device 10 having the configuration described above performs basic operations described hereunder. Specifically, the network camera device 10 is capable of performing such operations as an image pickup operation in which incident light is received from an object, and an image signal corresponding to a screen of an image picked up of the object is supplied via the network or the like; a camera driving operation in which the camera unit C is driven in, for example, the pan direction or the tilt direction; operations (such as a motion detection operation) in various operation modes in accordance with image signals indicative of the picked-up image; and various setting operations for producing settings of segment regions for the segmentation processing described below; and a self-test operation.

More specifically, the image pickup operation is performed under the control of the MPU 20 responsive to the operation program stored in the memory 21 upon receipt of an instruction signal from, for example, the PC 26, which is a control unit, via the network N (or the wireless network). Having received incident light from an object through the objective lens 11, the solid-state image pickup device 13 supplies a detection signal corresponding to the incident light to the image processing portion 16. After a predetermined image processing is applied, image compression such as JPEG compression or MPEG compression is performed in the image compression portion 17, the signal is output to the outside via the Ethernet communication portion 18 and the wireless LAN communication portion 19.

Additionally, in the camera driving operation, the MPU 20 all the time recognizes the direction of the current camera unit C after zero-coordination tuning in the pan motor 24 and the tilt motor 25 that are the stepping motors. Thereby, the MPU 20 all the time controls the coordinate of the screen of images being picked up by the currently operating camera unit C. More specifically, when the camera unit C is driven in the pan direction or the tilt direction in response to an operation control signal to be supplied from the MPU 20 to the driver and the image pickup screen is thereby varied, the MPU 20 is synchronously recognizing the coordinate of the current image pickup screen at all the time. As such, on the screen of the PC 26 or the like connected via the network, while viewing a image pickup screen corresponding to image signals continually being supplied from the current image pickup device 10, the user can move the camera unit C in the pan direction or the tilt direction, and the user can view a image pickup screen corresponding to the movement of the camera unit C. While the MPU 20 recognizes and manages the coordinate of the current image pickup screen, also the user can acquire information of the coordinate of the current image pickup screen through the PC 26 or the like in correspondence to operations.

In each individual operation mode, for example, a movement detection operation mode, the image pickup device 10 automatically detects the movement of an image in an arbitrary region set by the user from a PC existing as an external device on the network. More specifically, suppose that, in the movement detection operation mode, a movement-detection observation area in an image pickup screen is set by the user operation; and thereafter, in a set time, a variation greater than or equal to a predetermined value set for the image pickup screen is detected. In this event, the MPU 20 determines the occurrence of movement detection and performs operations, such as a warning operation to output an alarm signal, and addition of an alarm image screen data stored in the memory 21 to an image signal to output the signal.

(Setting Operation for Segment Region)

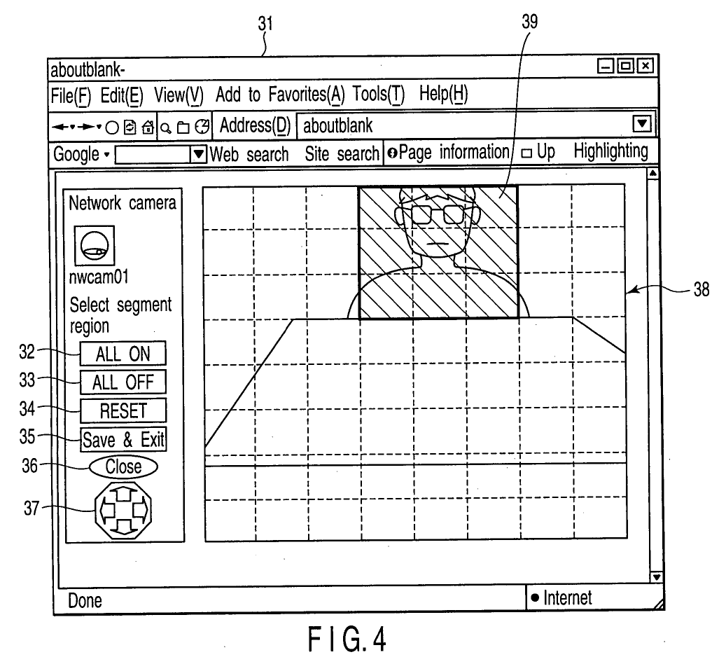

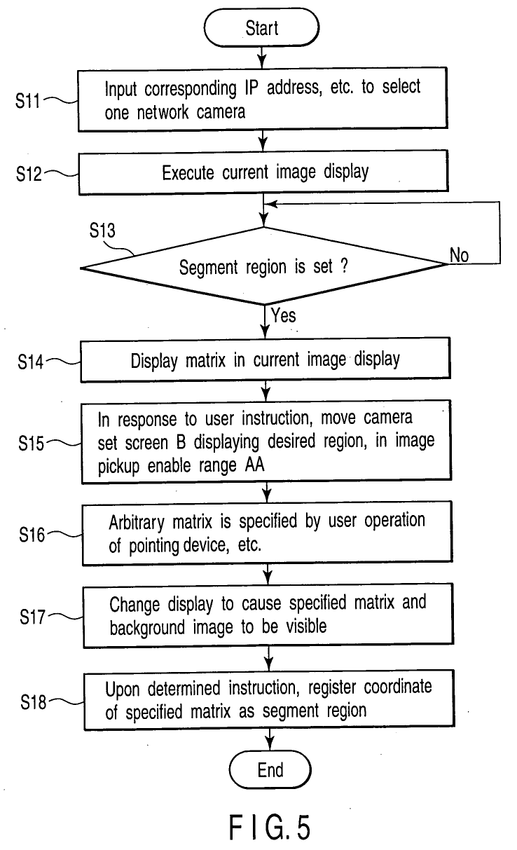

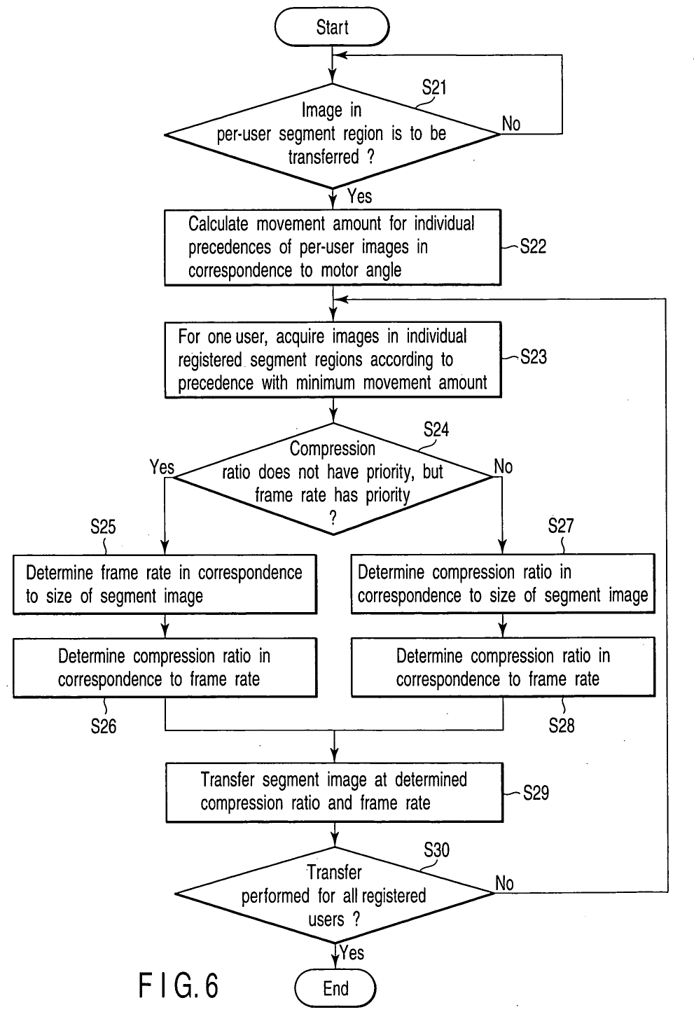

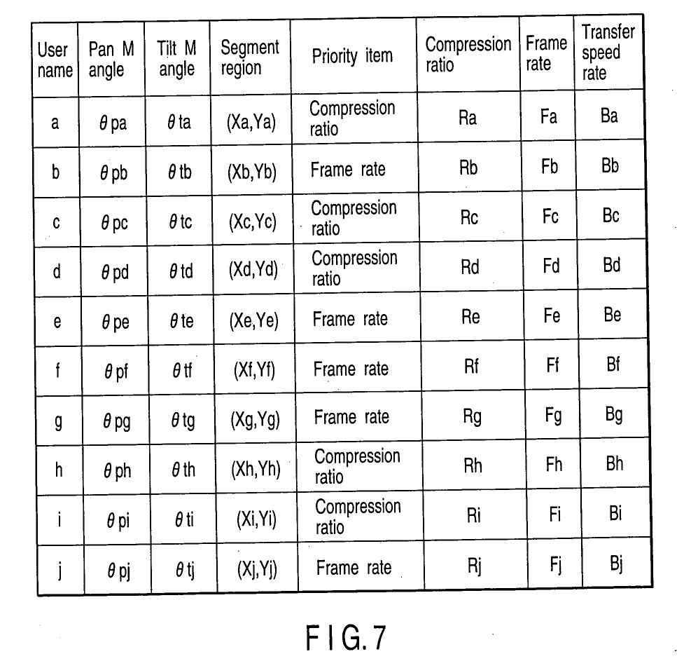

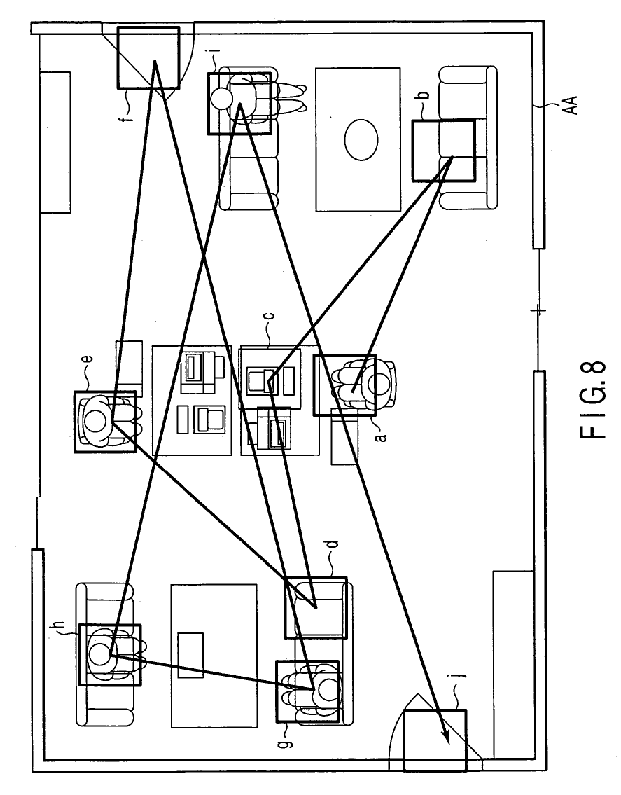

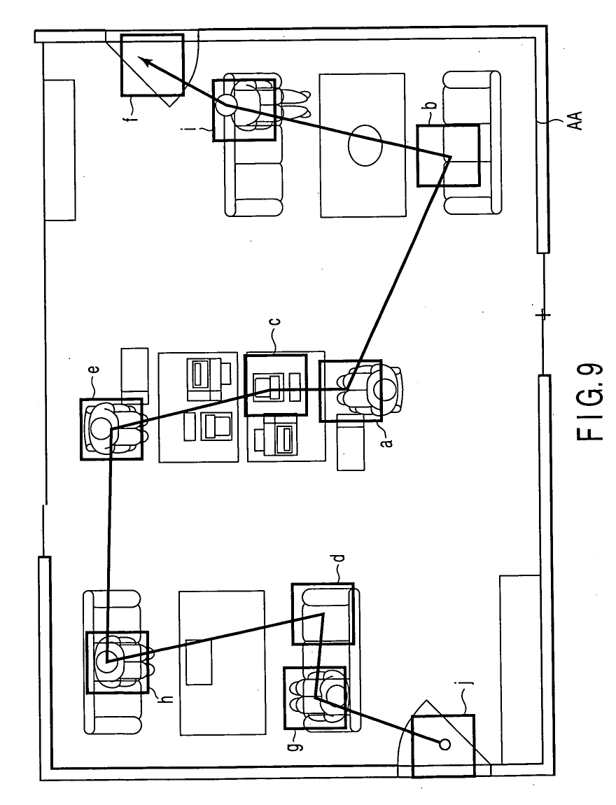

With reference to a flowchart, a description will be made hereinbelow in detail regarding setting operations of a segment region in the below-described segmentation processing for image information. FIG. 4 is an explanatory view showing an example operation screen for setting a segment region in the image pickup device of the invention; FIG. 5 is a flowchart showing an example of a method of setting a segment region in the image pickup device of the invention; FIG. 6 is a flowchart showing an example of a per-user transmission process; FIG. 7 is a view showing an example of per-user registrations of segment regions in the image pickup device of the invention; FIGS. 8 and 9 are views showing an example of a transmission process of the image pickup device of the invention.

The segment region in the network camera device 10 can be set in at least two cases. One case is that, as shown in FIG. 4, a segment region 39 is set in a current display screen 38 being currently displayed. The other case is that, as shown in FIGS. 8 and 9, the user operates the camera unit C to be moved in the pan or tilt direction thereby to shift from the current display screen to a desired screen in an image pickup enable range AA, which is a range of driving a function of the network camera device 10 and in which image pickup is possible; and thereafter, an arbitrary region in the desired screen 38 shown in FIG. 4 is set as the segment region 39.

An example case of the operation of setting the segment region according to the invention will now be described with reference to the flowchart of FIG. 5. Specifically, the case is exemplified such that a user operates the camera unit C to be moved in the pan or tilt direction thereby to move from a current display screen A to a desired screen B; and thereafter, an arbitrary region in the desired screen B is set as the segment region 39.

At the outset, the network camera devices 10 of the invention are supplied with an IP address signal specified from a control unit, such as the PC 26 residing on the network. In this case, one of the network camera devices 10 is selected to operate under the control of the PC 26 or the like when the supplied signal is determined to correspond to the Ethernet communication portion 18 or the wireless LAN communication portion 19 of the network camera device 10 (S31). Upon reception of an instruction for the image pickup operation from the PC 26, the image pickup operation is carried out under the control of the MPU 20, and a detection signal corresponding to incident light is supplied from the solid-state image pickup device 13 to the image processing portion 16. In the image processing portion 16, the input image signal undergoes image processings, such as the sharpness processing, contrast processing, gamma correction, white-balance processing, and pixel addition processing. Thereafter, in the image compression portion 17, the image signal undergoes JPEG compression or MPEG compression and is output via either one of the Ethernet communication portion 18 and the wireless LAN communication portion 19. The output image signal undergoes decompression processing in the PC 26, and is then displayed therein in the form of a screen of a browser application 31, as shown in FIG. 4 (S32).

In this stage, when the mode of setting the segment region is selected by the user (S33), a current image pickup screen 37 is displayed together with manipulation icons 31 to 37 in the screen of the browser application 31 shown in FIG. 4. By way of one example, the screen is preferably displayed by being segmented into a plurality of blocks (in a matrix form) (S34). In this case, the units of a region where the segment region can be set are specifically displayed, so that the user can securely be set a region for an object.

These manipulation icons are provided for a segment-region setting mode. An “ALL ON” icon 32 is used to set an entire screen to a segment region. An “ALL OFF” icon 33 is used to cancel the segment region set for the entire screen. A “RESET” icon 34 is used to cancel a segment region specified using a pointing device such as a mouse to return a set value to a default value. A “Save & Exit” icon 35 is used to confirm a segment region specified by the pointing device such as the mouse and to terminate the segment-region setting mode. A “Close” icon 36 is used to close the screen of that mode. An arrow icon 37 is used to move the camera unit C in the pan or tilt direction.

The setting of the segment region representing the image information according to the invention can thus be implemented in the current display screen A, as shown in FIG. 4. However, the setting is not limited to this manner, and can be implemented also for a desired region as long as the region is to be set in the image pickup enable range AA in which image pickup is possible by driving the camera unit C in the pan or tilt direction, as shown in FIGS. 8 and 9. Specifically, a user manipulates the arrow icon 37 or the like thereby to set the camera to a desired screen by moving it in the direction, for example, from a region a to a region b, as shown in FIG. 8 (S35). Then, the user operates with the pointing device such as the mouse 27 to thereby enable arbitrary blocks (in a matrix form) to be set as the segment region 39 from the desired screen 38 as shown in FIG. 4 (S36). Upon reception of coordinate information and an instruction signal from the PC 26 or the like via the network, the MPU 20 controls active display to be performed in a corresponding region set as the segment region 39 with semitransparent rectangular blocks or the like as shown in FIG. 4 in a state where a background image is visible (S37).

Suppose that, determining the set region to be defective, the user operates the mouse or the like and thereby supplies an instruction signal again to the MPU 20 via the network. In this case, the active display is canceled, and the screen is returned to a normal image pickup display that is equivalent to that in the other region, thereby enabling the user to implement very intuitive region specification.

Finally, for determination of the region on the current active display as the segment region 39, the user manipulates, for example, the “Save & Exit” icon 35, and supplies an instruction signal to the MPU 20 via the network. Upon the determination and instruction, the coordinates of instructed blocks (in a matrix form) are registered as a new segment region into, for example, the memory 21 (S38).

In this manner, in the set screen shown in FIG. 4, also the image in the segment region 39 is displayed, so that the user can securely set the per-user object as an intra-segment-region object by performing the very easy and intuitive operation.

Registration items of the segment region and the like will be described in detail hereunder. As shown in FIG. 7, the coordinate information (Xa, Ya) of the segment region 39 is registered together with own user names a to j. In this connection, it is preferable that not only the above, but also a corresponding pan motor angle θpa and a corresponding tilt motor angle θta (which constitute positional coordinate information) are concurrently registered by way of specification regarding the pan motor 24 and the tilt motor 25 for driving the camera unit C, which is the above-described image pickup portion provided to enable the image region in which the segment region 39 is present. In addition, priority items of process parameters at the time of transfer processing are registered; more specifically, whether the compression ratio is handled with priority or the frame rate is handled with priority, for example, is registered. Further, it is preferable that desired per-user transfer speed rates Ba to Bj be registered. An example of the transfer speed rate is 1×10⁶ bits/sec. It is further preferable that process parameters desired by other users for transfer processing be registered.

According to volumes of predicted image information corresponding to coordinates from the plurality of the above-described process parameters, and segment regions, the optimal compression ratio and frame rate are automatically calculated by the MPU 20 or the like, and are stored into the memory 21 or the like.

(Communication Method Involving Segmentation Processing)

A communication method involving the segmentation processing of the invention will now described below in detail. Description will be made with reference to FIG. 6 regarding an example case where the image pickup device 10 of the invention receives request signals from users for image information picked up by the solid-state image pickup device 13 serving as the image pickup portion, and responsively transmits the information. First, upon receipt of operation information requiring transfer of image information in registered per-user segment regions (S21), the method references the angles of the pan motor 24 and the tilt motor 25, which are shown in FIG. 7 as the registration information. Then, when acquiring the image information in the segment regions corresponding to the users a to j, the method calculates movement times/movement amounts by considering associations of acquirement precedences of segment images (S22), and obtains an acquirement precedence with a minimum motor movement distance, for example (S23).

More specifically, as shown in FIG. 8, when the segment regions are acquired simply in accordance with registration precedences of a plurality of users, a case can occur where the movement amounts of, for example, the pan motor and the tilt motor are extremely increased. In the drawing, an arrow indicates the transition of the viewpoint of the image pickup unit C in the image pickup portion so as to acquire the image information in the segment regions of the users A to j with the registration precedences. Additionally, FIG. 9 shows an example case where the movement amount of the image pickup unit C is minimum. By way of an example, the drawing shows acquirement precedences of segment images. More specifically, there are shown the acquirement precedences in the order from the user j, the user g, user d, user h, . . . user b, user i, and user f, and the difference thereof from FIG. 9 is conspicuous. However, the image pickup device of the invention does not indispensably require such optimizing processing for the acquirement precedences of the segment images.

Subsequently, optimizing processing for the process parameters is executed so that the parameters are optimized in units of the user to the transfer environments desired by the individual users. More specifically, by way of an example case, the transfer speed rates Ba to Bj to which the highest priority should be assigned for the individual users are first provided, and a verification is made which of the compression ratio and the frame rate has priority (S24). However, these priority items are presented just by way of example, and it is preferable that other process parameters be held as options selectable as desired by the individual users.

By way of an example, the relationship among the transfer speed rate, the compression ratio, the image volume in the segment region, and the frame rate is expressed by
(Transfer speed rate)=(Compression ratio)×(Image volume in segment region)×(Frame rate).
Accordingly, the compression ratio and the frame rate can be obtained corresponding to a user-desired priority item (the compression ratio, for example) by obtaining the image volume from the coordinate information of the segment region. The frame rate determines how many frames of image information processed per second.

If the frame rate has priority (S24), the method determines a frame rate that implements the desired transfer speed rate corresponding to the volume of the segment image (S25), and then determines a compression ratio corresponding to the frame rate (S26). In this case, the desired frame rate is guaranteed after the transfer speed rate has been guaranteed.

On the other hand, if the compression ratio has priority (S24), the method determined a compression ratio that implements the desired transfer speed rate corresponding to the volume of the segment image (S27), and then determines a frame rate corresponding to the compression ratio (S28). In this case, the desired compression ratio is guaranteed after the transfer speed rate has been guaranteed.

As another embodiment, when the transfer speed rate also is included to the objects of the priority items, the frame rate can also be set as an absolute value and the compression ratio can be set as an absolute value. Alternatively, a method is preferable in which, the (image volume in segment region) value is not predicted from the coordinate information of the segment image, but the (image volume in segment region) value is instead obtained after the segment image has been acquired, whereby the process parameters such as (transfer speed rate), (compression ratio), and (frame rate) are optimized each time the (image volume in segment region) value is obtained.

Under a transmission environment according to the optimized process parameters, the segment image is transmitted to an external device P or the like present on the network (S29). The transmission processing described above is sequentially performed for each of all the users a to j (S30).

As described above, according to the image pickup device of the invention, the image information in the segment region required by each of the plurality of users is transmitted under the transmission environment having been automatically optimized according to the process parameters desired by the each individual user. Thereby, transmission processing for the image information in the segment region can be implemented corresponding to conditions required by the external device possessed by each of the plurality of users.

The above embodiment has been described with reference to the example cases where the segment images desired by the individual users are secured when the positions of the pan motor and the tilt motor are all different. However, the desired segment images can be similarly secured even in a case where segment images corresponding to the plurality of users can be acquired from image information in the same position. In this case, electronic tilt processing from one-screen image information is possible, thereby enabling the segmentation processing to be implemented without driving, for example, the pan motor and the tilt motor.

According to the invention, requests for segment regions are received from a plurality of users (a plurality of external devices), priority items of process parameters are concurrently received, and image information of the segment regions are transmitted in response thereto under optimal transmission environments. More specifically, in addition to segment regions in an image screen, parameters such as transfer speed rates and priority items such as compression ratios with priority and frame rates with priority are provided from a plurality of users. Then, appropriate compression ratios are determined, and frame rates corresponding thereto are further determined in accordance with the information of, for example, volumes of image information in the segment regions, desired transfer speed rates, and compression ratios with priority. Thereby, not only simple screen information in the segment region desired by the user, but also individual transmission processings can be automatically implemented with appropriate image quality when the user is desirous of image quality (compression ratio with priority) and at a transfer speed rate desired with the frame rate for guaranteeing stable transmission when the user is desirous of the stable transmission (frame rate with priority). Consequently, according to the image pickup device of the invention, distribution processing for appropriate image information can be automatically implemented corresponding to the different requests of the plurality of users.

According to the various embodiments described above, those skilled in the art will be able to implement the invention, and various other modified examples of the various embodiments will easily occur to those skilled in the art. Further, it will be possible even for those not having sufficient inventive knowledges and skills to adapt the invention by way of various other embodiments. Thus, the invention covers a broad range of applications as long as they do not contradict the principles and novel features disclosed herein; that is, the invention is not limited to the embodiments described hereinabove.

1. An image pickup device comprising:
an image pickup portion which picks up an image;
a communication portion which makes communication with a plurality of external devices on a network;
a setting portion which receives a signal from each of said plurality of external devices via the communication portion and sets a segment region of image information to be transmitted to the each external device and priority items of process parameters when the image information is transmitted; and
a control portion which, upon determining process parameters in accordance with the priority items of the process parameters, transmits image information in the segment region, which is set in units of the each external device from the image information of the image picked up by the image pickup portion, to the each device on the network via the communication portion in correspondence to the determined process parameters.

2. An image pickup device according to claim 1, wherein, in accordance with a transfer speed rate for the image information in the segment region and the priority items that are provided in the setting portion, the control portion automatically determines a compression ratio and a frame rate in correspondence thereto according to precedences of the priority items.

3. An image pickup device according to claim 1, wherein in accordance with a transfer speed rate for the image information in the segment region and the priority items that are provided in the setting portion, the control portion first determines one of a compression ratio and a frame rate provided as the priority items in correspondence to the transfer speed rate, and then determines the other one of the compression ratio and the frame rate in correspondence to the transfer speed rate.

4. An image pickup device according to claim 1, wherein the setting portion perform setting of segment regions in units of said plurality of external devices in correspondence to operation signals corresponding to screens of the external devices connected by the communication portion.

5. An image pickup device according to claim 4, wherein the setting portion performs the setting of the segment region in a manner that, in a state where the image picked up by the image pickup portion is displayed as a plurality of block regions on display screens of the external devices brought into communication via the communication portion, when a predetermined region on the display screen is specified in accordance with an instruction signal, the predetermined region is displayed in the image in a state where the predetermined region can be identified from other regions.

6. An image pickup device according to claim 4, wherein, when a predetermined region on the display screen is specified, the setting portion outputs, via the communication portion, region information generated to be displayed in the image in a state where a user can identify an image in the predetermined region similarly to images in other regions.

7. An image pickup device according to claim 4, further comprising:
an image compression portion which performs image compression of information of the picked-up image to display the image in a browser application in the external device via the communication portion.

8. An image pickup device according to claim 1, further comprising:
at least one of a driving portion which drives the image pickup portion in a pan direction and a driving portion which drives the image pickup portion in a tilt direction,
wherein the setting portion sets the segment region within an image pickup enable range in which image pickup becomes possible according to the movement of the image pickup portion by the driving portion.

9. An image pickup device according to claim 8, wherein the setting portion performs the setting with position information of the driving portion when performing the setting of the segment regions in units of said plurality of external devices.

10. An image pickup device according to claim 8, wherein the setting portion performs the setting with position information of the driving portion when performing the setting of the segment regions in units of said plurality of external devices, and
in the case of acquiring image information in the segment regions in units of said plurality of external devices, when performing image pickup of the image information in the segment regions, the control portion performs calculation of an overall driving amount of the driving portion in accordance with plural items of position information of the driving portion, determines acquirement precedences of said plurality of segment regions in accordance with the calculation results, acquires the image information in the segment regions in units of said plurality of external devices in accordance with the determined acquirement precedences, and performs control for transmission thereof to the individual external devices.

11. An image pickup method comprising:
picking up an image and outputting image information;
receiving a signal from each of a plurality of external devices via a communication portion, and setting a segment region of image information to be transmitted to the each external device and priority items of process parameters when the image information is transmitted; and
upon determining process parameters in accordance with the priority items of the process parameters, controlling to transmit image information in the segment region, which is set in units of the each external device from the image information of the image picked up by the image pickup portion, to the each device on the network in correspondence to the determined process parameters.

12. An image pickup method according to claim 11, wherein, in the control, in accordance with a transfer speed rate for the image information in the segment region and the priority items that are provided in the setting portion, a compression ratio and a frame rate are automatically determined in correspondence thereto according to precedences of the priority items.

13. An image pickup method according to claim 11, wherein, in the control, in accordance with a transfer speed rate for the image information in the segment region and the priority items that are provided in the setting portion, one of a compression ratio and a frame rate provided as the priority items is first determined in correspondence to the transfer speed rate, and the other one of the compression ratio and the frame rate is then determined in correspondence to the transfer speed rate.

14. An image pickup method according to claim 11, wherein, in the setting, segment regions in units of said plurality of external devices are set in accordance with operation signals corresponding to screens of the external devices connected by the communication portion.

15. An image pickup method according to claim 14, wherein the setting of the segment region is performed in a manner that, in a state where the image picked up by the image pickup portion is displayed as a plurality of block regions on display screens of the external devices brought into communication via the communication portion, when a predetermined region on the display screen is specified in accordance with an instruction signal, the predetermined region is displayed in the image in a state where the predetermined region can be identified from other regions.

16. An image pickup method according to claim 14, wherein, in the setting, when a predetermined region on the display screen is specified, region information generated to be displayed in the image in a state where a user can identify an image in the predetermined region is output to the outside similarly to images in other regions.

17. An image pickup method according to claim 14, wherein image compression is performed to image information of the picked-up image to display the image in a browser application in the external device.

18. An image pickup method according to claim 11, wherein, in the setting, in the case of image pickup by moving the image pickup portion to pick up an image in at least one of a driving portion in a pan direction and a tilt direction, the segment region is set within an image pickup enable range in which image pickup becomes possible according to the movement of the image pickup portion.

19. An image pickup method according to claim 18, wherein, in the setting, the setting is performed with position information of the driving portion when performing the setting of the segment regions in units of said plurality of external devices.

20. An image pickup method according to claim 18, wherein, in the setting, the setting is performed with position information of the driving portion when performing the setting of the segment regions in units of said plurality of external devices, and
in the control, in the case of acquiring image information in the segment regions in units of said plurality of external devices, calculation of an overall driving amount of the driving portion when performing image pickup of the image information in the segment regions in accordance with plural items of position information of the driving portion, acquirement precedences of said plurality of segment regions are determined in accordance with the calculation results, the image information of the segment regions in units of said plurality of external devices is acquired in accordance with the determined acquirement precedences, and control is performed for transmission thereof to the individual external devices.
